(19) United States
(12) Patent Application Publication
(10) Pub. No.: US 2014/0016142 A1
(43) Pub. Date: Jan. 16, 2014

(54) PRINTING THE IDENTITY OF UNSUPPORTED FORMATTING ATTRIBUTES

(71) Applicant: Takayuki Kamata, Boulder, CO (US)

(72) Inventor: Takayuki Kamata, Boulder, CO (US)

(73) Assignee: KONICA MINOLTA LABORATORY U.S.A., INC., San Mateo, CA (US)

(21) Appl. No.: 13/549,209

(22) Filed: Jul. 13, 2012

(51) Int. Cl. G06K 15/02

(52) U.S. Cl. 358/1.6

(57) ABSTRACT

A method for printing documents, including: receiving, by a printer and from a device, an electronic document (ED) having a first formatting attribute and a second formatting attribute; determining, by the printer and during a layout of the ED, that the first formatting attribute is supported by the printer and that the second formatting attribute is unsupported by the printer; generating, by the printer and based on the layout, a hardcopy of the ED according to the first formatting attribute and having a printed value identifying the second formatting attribute.

### BACKGROUND

Many users generate electronic documents (EDs) on a daily basis. Moreover, these EDs may have very sophisticated layouts that are specified using many different formatting attributes. When a printer receives an ED for printing, it is possible that one or more of the formatting attributes specified in the ED are not supported by the printer. As a result, the hardcopy of the ED may have a layout/appearance that differs from the expected layout/appearance. Moreover, it may be difficult to establish from looking at the hardcopy of the ED, which formatting attributes are not supported by the printer and causing the deviation from the expected layout/appearance. Regardless, user still wish to generate and print EDs using many different formatting attributes.

### SUMMARY

In general, in one aspect, the invention relates to a method for printing documents. The method comprises: receiving, by a printer and from a device, an electronic document (ED) comprising a first formatting attribute and a second formatting attribute; determining, by the printer and during a layout of the ED, that the first formatting attribute is supported by the printer and that the second formatting attribute is unsupported by the printer; generating, by the printer and based on the layout, a hardcopy of the ED according to the first formatting attribute and comprising a printed value identifying the second formatting attribute.

In general, in one aspect, the invention relates to a non-transitory CRM storing instructions for printing documents. The instructions comprise functionality to: receive, using a printer and from a device, an electronic document (ED) comprising a first formatting attribute and a second formatting attribute; determine, during a layout of the ED using the printer, that the first formatting attribute is supported by the printer and that the second formatting attribute is unsupported by the printer; generating, based on the layout and using the printer, a hardcopy of the ED according to the first formatting attribute and comprising a printed value identifying the second formatting attribute.

In general, in one aspect, the invention relates to a system for printing documents. The system comprises: a processor; an input module executing on the processor and configured to receive, from a device, an electronic document (ED) comprising a first formatting attribute and a second formatting attribute; a parsing module executing on the processor and configured to determine, during a layout of the ED, that the first formatting attribute is supported and that the second formatting attribute is unsupported; and a layout engine executing on the processor and configured to generate a hardcopy of the ED according to the first formatting attribute and comprising a printed value identifying the second formatting attribute.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3 shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for printing the identity of unsupported formatting attributes in a hardcopy of an ED. Specifically, a printer receives an electronic document (ED) having one or more formatting attributes; the printer determines which formatting attribute(s) in the ED are support by the printer and which formatting attribute(s) are unsupported (i.e., not supported) by the printer; and the printer generates a hardcopy of the ED based on the formatting attribute(s) that are supported by the printer. The hardcopy of the ED includes one or more printed values identifying the formatting attribute(s) that were specified in the ED but unsupported by the printer. The printed values may also identify the page(s) in the hardcopy where the formatting attributes were specified/present.

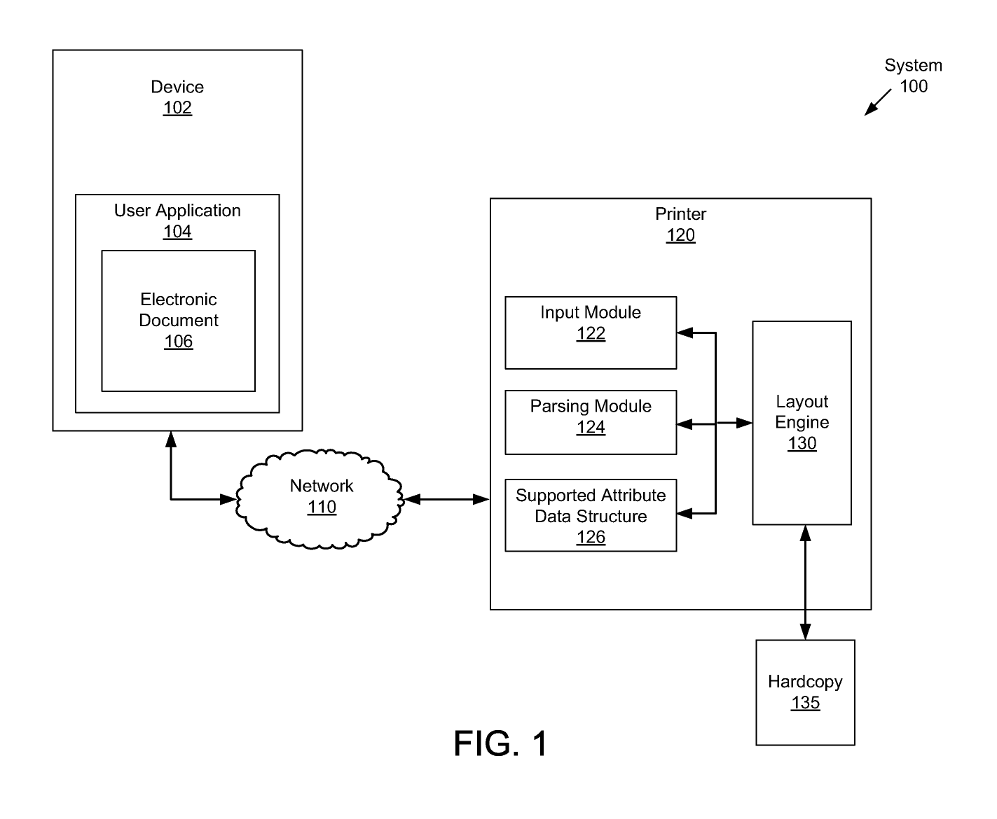

FIG. 1 shows a system (100) in accordance with one or more embodiments of the invention. As shown in FIG. 1, the system (100) has multiple components including device (102) and printer (120) connected via a network (110) with wired and/or wireless segments. The device (102) may correspond to a server, a mainframe, a desktop Personal Computer (PC), a laptop, a Personal Digital Assistant (PDA), a telephone, a smart phone, a kiosk, a cable box, and/or any other hardware device.

In one or more embodiments of the invention, the device (102) executes the user application (104). The user application (104) is a software application operated by a user and configured to obtain, input, generate, display, and/or print an ED (e.g., Electronic Document (106)) having any number of pages. Accordingly, the user application (104) may be a word processor, slide presentation software, spreadsheet software, graphics software, Internet browser, desktop publishing software, video editor, and so forth. The ED (106) may be a report or form.

In one or more embodiments of the invention, the ED (106) includes one or more formatting attributes. In other words, the formatting attributes are specified in the ED (106). The formatting attributes define and establish the layout, appearance, and/or structure of the ED (106) when the ED (106) is displayed and/or printed. Formatting attributes include, but are not limited to: font style, font size, bold, italics, underline, charts, tables, clip art, font spacing, indention, margins, highlighting, colors, end notes, footnotes, headers, and/or any other attribute that may affect the layout, appearance, or structure of the ED (106). It will be apparent to one of ordinary skill in the art that many different attributes may be a formatting attribute and, as such, the invention should not be limited to the above examples.

In one or more embodiments of the invention, the ED (106) is represented/defined using a document markup language (e.g., open document format (ODF), office open XML (OOXML), etc.). Accordingly, the formatting attributes in the ED (106) may be recorded as attributes within the tags of the document markup language. Moreover, these properties/attributes are needed to correctly render the ED (106) for display or printing.

In one or more embodiments of the invention, the printer (120) is a Multi-Function Printer (MFP). A MFP is a printer that includes other functionality such as scanning or faxing, and typically has a user interface, such as a touch screen, allowing complex interactions to be performed at the MFP itself, rather than having to use another device, such as a computer. It will be clear to one of ordinary skill in the art that many different functionalities may be included in a MFP and, as such, the invention should not be limited to the above examples.

In one or more embodiments of the invention, the printer (120) includes an input module (122). The input module (122) may be configured to receive the ED (106) from device (102) and store the ED (106) in a queue (not shown). The input module (122) may prioritize the ED (106) with respect to the other EDs (not shown) already stored in the queue.

In one or more embodiments of the invention, the printer (120) includes a parsing module (124). The parsing module (124) may be configured to determine which formatting attribute(s) in the ED (106) are supported by the printer (120). The parsing module (124) may be configured to determined which formatting attribute(s) in the ED (106) are unsupported (i.e., not supported) by the printer (120). Specifically, during a parsing of the ED (106), the parsing module (124) may compare one or more of the encountered formatting attributes to the supported attribute data structure (126). If a match is found (i.e., the encountered formatting attribute is on the supported attribute data structure (126)), the formatting attribute is deemed to be supported by the printer (120). However, if no match is found, the formatting attribute is deemed to be unsupported by the printer (120). The supported attribute data structure (126) may be a list, a queue, a linked-list, a database, or any type of repository.

In one or more embodiments of the invention, the printer (120) includes a layout engine (130). The layout engine (130) is configured to generate the hardcopy (135) of the ED (106) (i.e., print the ED (106)). In one or more embodiments of the invention, the layout engine (130) may generate page images. In the case of EDs described/represented using a document markup language (e.g., OOXML), the layout engine (130) may calculate the page positions (i.e., coordinates) of all elements on the pages. In other words, the layout engine (130) may execute a layout of the ED (106) according to the formatting attributes specified in the ED (106) and supported by the printer (120).

In one or more embodiments of the invention, the layout engine (130) generates an extra/separate hardcopy page with one or more printed values. The printed values may identify the one or more formatting attributes in the ED (106) that are unsupported by the printer (120) and/or the pages of the hardcopy (135) on which the unsupported formatting attributes were located. In one or more embodiments of the invention, the extra page with the printed values is placed on the end of the hardcopy (135). In one or more embodiments of the invention, the extra page is placed at the front of the hardcopy (135). In one or more embodiments of the invention , the printed values are placed on the actual pages of the hardcopy (135) where the unsupported attributes are specified.

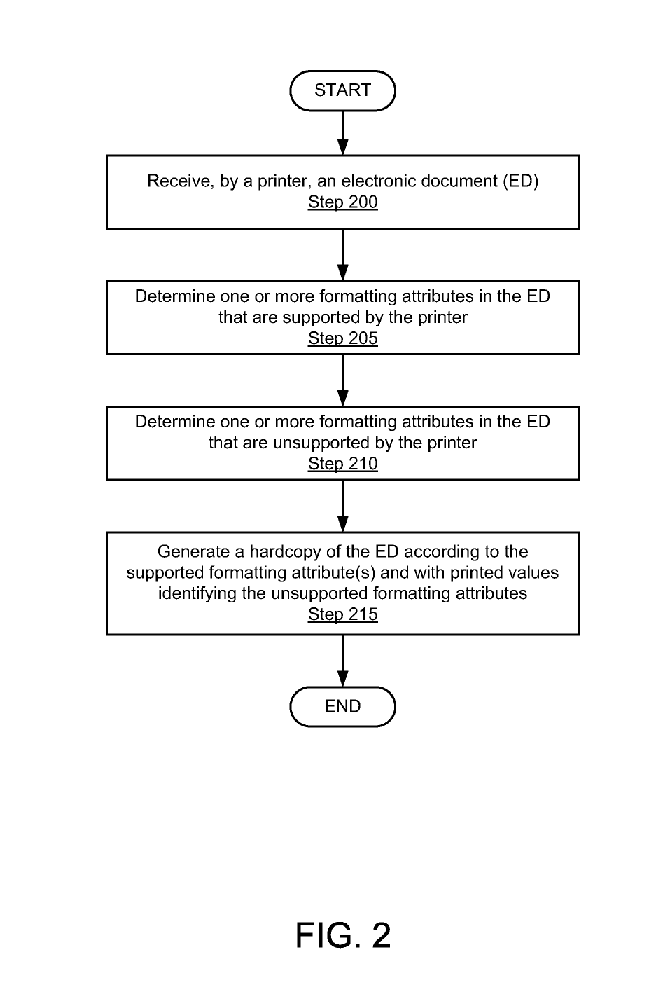

FIG. 2 shows a flowchart in accordance with one or more embodiments of the invention. The process shown in FIG. 2 may be used, for example, with the components of system (100) (e.g., printer (120), discussed above in reference to FIG. 1) to print the identity of unsupported formatting attributes. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

In Step 200, an ED is received by a printer. In one or more embodiments of the invention, the ED is received from a mobile device through a network of any size having wired and/or wireless segments. The received ED may be stored in a queue and prioritized with respect to other EDs already stored in the queue.

In Step 205, the formatting attributes specified in the ED and supported by the printer are determined. As described above, a formatting attribute is any attribute that affects the layout, appearance, or structure of the ED. In one or more embodiments of the invention, the determination may be made by parsing the ED and comparing the encountered formatting attributes against a list of printer supported attributes. Alternatively, this may be done in any another other acceptable method now known or later developed.

In Step 210, the formatting attributes specified in the ED and unsupported by the printer are determined. As in Step 205, the determination may be made by parsing the ED and comparing any encountered formatting attribute against a list of printer supported attributes. If a match is not found, the encountered formatting attribute is deemed to be unsupported by the printer. Those skilled in the art, having the benefit of this detailed description, will appreciate that STEP 205 and STEP 210 may be merged into a single step. In such embodiments, during a parsing of the ED, any encountered formatting attribute is compared against a data structure storing the formatting attributes supported by the printer. If a match is found, the formatting attribute is deemed to be supported by the printer. If not match is found, the formatting attribute is deemed to be unsupported by the printer. Alternatively, this may be done in any another other acceptable method now known or later developed.

In Step 215, a hardcopy of the ED is generated according to the one or more supported formatting attributes specified in the ED. Specifically, the hardcopy is generated by executing a layout (i.e., using a layout engine) of the ED according to the one or more supported formatting attributes. In one or more embodiments of the invention, the hardcopy of the ED includes one or more printed values. The printed values identify the one or more formatting attributes specified in the ED that are unsupported by the printer. The printed values may be placed on a separate/extra page of the hardcopy document. In one or more embodiments of the invention, this separate page may be the last page printed. Alternatively, it may be the first page printed or at any other suitable location. In one or more embodiments of the invention, the printed values are placed as a footnote, endnote, or at any other suitable location within the hardcopy. In one or more embodiments of the invention, the printed values include additional information, such as a page number or other location(s) within the ED where the unsupported formatting attributes are specified. In one or more embodiments of the invention, printed values mirror the unsupported formatting attributes as they appear in the markup or code of the ED.

The following section describes various examples of the invention. The examples are included to aid in the understanding of the invention but are not intended to limit the scope of the invention.

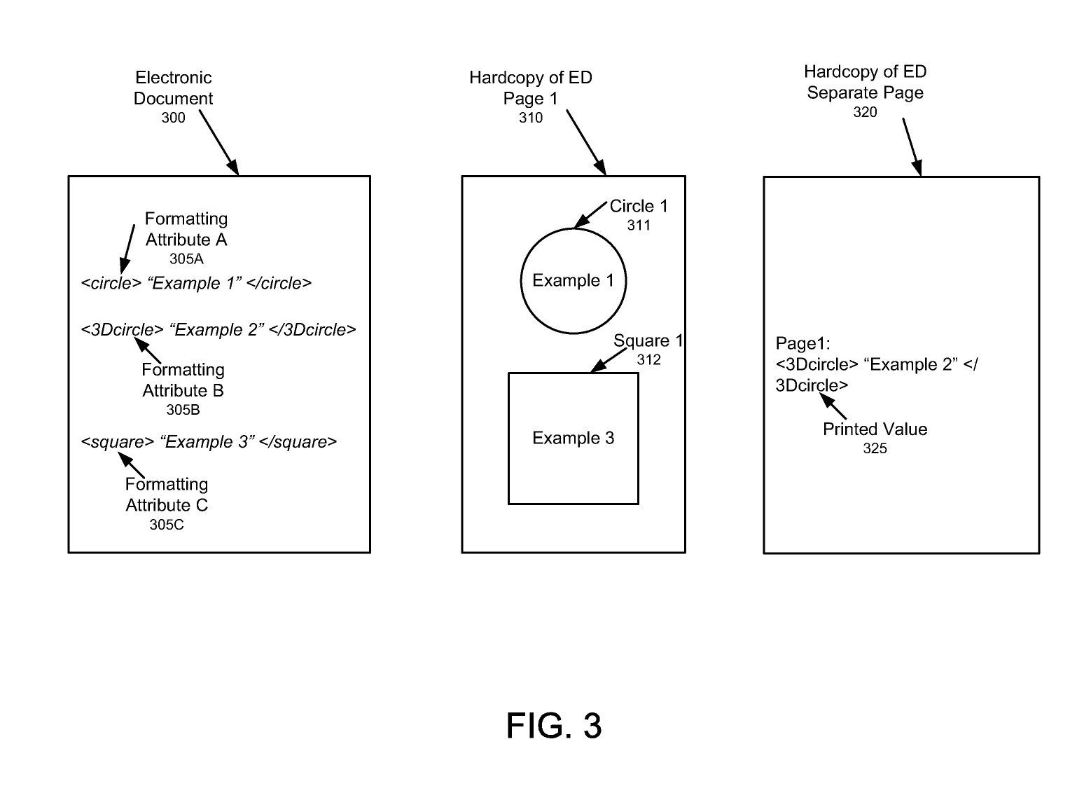

FIG. 3 depicts an ED (300) in accordance with one or more embodiments of the invention. The ED (300) is stored as an OOXML document. As shown in FIG. 3, the ED (300) includes three formatting attributes: Formatting Attribute A (305A), Formatting Attribute B (305B), and Formatting Attribute C (305C). Moreover, the formatting attributes (305A, 305B, 305C) are expressed as tags.

For example, Formatting Attribute A (305A) is specified using the tag <circle> “Example 1” </circle> and corresponds to drawing a circle with the text “Example 1” placed inside the circle. As another example, Formatting Attribute B (305B) is specified using the tag <3Dcircle> “Example 2” </3Dcircle>. As yet another example, Formatting Attribute C (305C) is specified using the tag <square> “Example 3” </square> and corresponds to drawing a square with the text “Example 3” placed inside the square.

In this example, assume the ED (300) is sent to a printer that supports

Formatting Attribute A (305A) and Formatting Attribute C (305C), but does not support Formatting Attribute B (305B). In other words, Formatting Attribute B (305B) is unsupported by the printer. During a parsing of the ED (300) by the printer, the encountered formatting attributes will be deemed as either supported (305A, 305C) or unsupported (305B). The printer will generate a hardcopy of the ED (300) based on the supported formatting attributes (305A, 305C).

FIG. 3 includes page 1 (310) of the hardcopy of the ED (300). As shown in FIG. 3, page 1 (310) includes both circle 1 (311) and square 1 (312) corresponding to Formatting Attribute A (305A) and Formatting Attribute C (305C), respectively. However, the shape corresponding to Formatting Attribute B (305B) does not appear on page 1 (310) because Formatting Attribute B (305B) is not supported by the printer. Instead, the hardcopy includes a separate page (320) with a printed value (325). The printed value (325) identifies the unsupported Formatting Attribute B (305B) and the page (i.e., page 1) on which the Formatting Attribute B (305B) was specified.

Thus, in one or more embodiments of the invention, when the hardcopy is generated, additional data is printed detailing any formatting attributes that are unsupported by the printer, including the location of the unsupported formatting attributes. Those of ordinary skill in the art, having the benefit of this detailed description, will appreciate that the location information may come in any form such as page number, line number, column number, or any other suitable information with which to identify a location on an electronic document. In this example, the printed value (325) is placed on a separate page (320) within the hardcopy of the ED (300). In one or more embodiments of the invention, the printed value (325) may be positioned in the header or footer of page 1 (310) and/or on a first page (e.g., cover page) of the hardcopy.

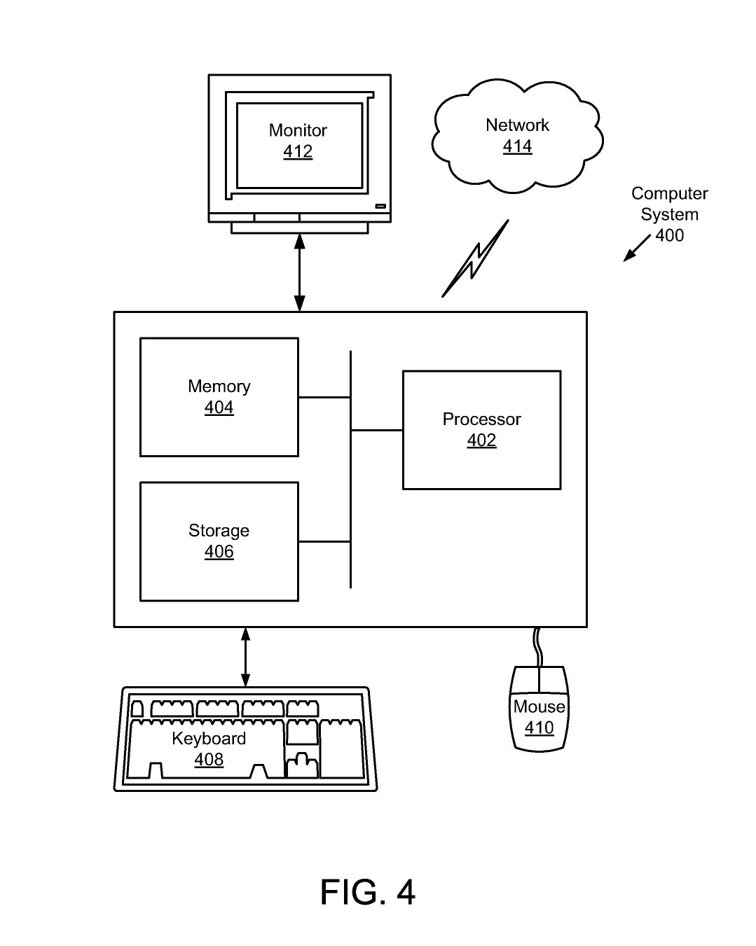

Embodiments of the invention may be implemented on virtually any type of computer regardless of the platform being used. For example, as shown in FIG. 4, a computer system (400) includes one or more processor(s) (402), an associated memory (404) (e.g. random access memory (RAM), cache memory, flash memory, etc.), a storage device (406) (e.g. a hard disk, an optical drive such as a compact disk drive or digital video disk (DVD) drive, a flash memory stick, etc.), and numerous other elements and functionalities typical of today's computers (not shown). In one or more embodiments of the invention, the processor (402) is hardware. For example, the processor may be an integrated circuit. The computer system (400) may also include input means, such as a keyboard (408), a mouse (410), or a microphone (not shown). Further, the computer system (400) may include output means, such as a monitor (412) (e.g. a liquid crystal display (LCD), a plasma display, or cathode ray tube (CRT) monitor). The computer system (400) may be connected to a network (414) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, the computer system (400) includes at least the minimal processing, input, and/or output means necessary to practice embodiments of the invention.

Further, in one or more embodiments of the invention, one or more elements of the aforementioned computer system (400) may be located at a remote location and connected to the other elements over a network. Further, embodiments of the invention may be implemented on a distributed system having a plurality of nodes, where each portion of the invention (e.g. the computing device, the multifunction printer) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for printing documents, comprising:
receiving, by a printer and from a device, an electronic document (ED) comprising a first formatting attribute and a second formatting attribute;
determining, by the printer and during a layout of the ED, that the first formatting attribute is supported by the printer and that the second formatting attribute is unsupported by the printer;
generating, by the printer and based on the layout, a hardcopy of the ED according to the first formatting attribute and comprising a printed value identifying the second formatting attribute.

2. The method of claim 1, wherein the ED is described in OOXML.

3. The method of claim 2, wherein the second formatting attribute is specified using a tag.

4. The method of claim 1, wherein determining comprises:
comparing the first formatting attribute and the second formatting attribute against a data structure of supported formatting attributes.

5. The method of claim 1, wherein the printed value is located on a final page of the hardcopy.

6. The method of claim 1, wherein the printer is a Multi-Function Printer (MFP) comprising a processor and a memory.

7. The method of claim 1, wherein the device is a mobile device.

8. A non-transitory computer-readable medium (CRM) storing a plurality of instructions for printing documents, the plurality of instructions comprising functionality to:
receive, using a printer and from a device, an electronic document (ED) comprising a first formatting attribute and a second formatting attribute;
determine, during a layout of the ED using the printer, that the first formatting attribute is supported by the printer and that the second formatting attribute is unsupported by the printer;
generating, based on the layout and using the printer, a hardcopy of the ED according to the first formatting attribute and comprising a printed value identifying the second formatting attribute.

9. The non-transitory CRM of claim 8, wherein the ED is described in OOXML.

10. The non-transitory CRM of claim 9, wherein the second formatting attribute is specified using a tag.

11. The non-transitory CRM of claim 8, wherein the instructions to determine comprise functionality to:
compare the the first formatting attribute and the second formatting attribute against a data structure of supported formatting attributes.

12. The non-transitory CRM of claim 8, wherein the printed value is located on a final page of the hardcopy.

13. The non-transitory CRM of claim 8, wherein the printer is a Multi-Function Printer (MFP) comprising a processor and a memory.

14. The non-transitory CRM of claim 8, wherein the device is a mobile device.

15. A system for printing documents, comprising:
a processor;
an input module executing on the processor and configured to receive, from a device, an electronic document (ED) comprising a first formatting attribute and a second formatting attribute;
a parsing module executing on the processor and configured to determine, during a layout of the ED, that the first formatting attribute is supported and that the second formatting attribute is unsupported; and
a layout engine executing on the processor and configured to generate a hardcopy of the ED according to the first formatting attribute and comprising a printed value identifying the second formatting attribute.

16. The system of claim 15, wherein the ED is described in OOXML.

17. The system of claim 16, wherein the second formatting attribute is specified using a tag.

18. The system of claim 15, wherein the parsing module is further configured to:
compare the first formatting attribute and the second formatting attribute against a data structure of supported formatting attributes.

19. The system of claim 15, wherein the printed value is located on a final page of the hardcopy.

20. The system of claim 15, wherein the system is a Multi-Function Printer (MFP).
